(19) United States
(12) Patent Application Publication
(10) Pub. No.: US 2017/0117090 A1
(43) Pub. Date: Apr. 27, 2017

(54) ENERGY STORAGE APPARATUS

(71) Applicant: Chicony Power Technology Co., Ltd., New Taipei City (TW)

(72) Inventors: Chin-Jen LIU, New Taipei City (TW); Tsung-Hsun HO, New Taipei City (TW); Chao-Jui HUANG, New Taipei City (TW)

(21) Appl. No.: 14/924,390

(22) Filed: Oct. 27, 2015

(51) Int. Cl. H01F 27/29; H01F 27/28

(52) U.S. Cl. CPC H01F 27/292; H01F 27/2823

(57) ABSTRACT

An energy storage apparatus includes a core and a first coil. The core has a winding portion, and the first coil includes a first coil body and a first pin portion. The first coil body is formed by winding a flat conductor around the winding portion perpendicularly and has a first inner end and a first outer end, and an edge of the first coil body has a notch to form a first wire crossing slot. The first pin portion includes a first inner end pin and a first outer end pin coupled to the first inner end and the first outer end respectively. The first inner end pin passes through a first wire crossing slot and crosses the first coil body to achieve the effects of reducing the overall volume and inserting components easily and quickly.

### FIELD OF THE INVENTION

The technical field relates to an energy storage apparatus, more particularly to the energy storage apparatus capable of reducing the overall volume and inserting components easily and quickly.

### BACKGROUND OF THE INVENTION

An energy storage apparatus may be an inductor having a single coil or a transformer having a plurality of coils, and most conventional coils are composed of a plurality of stranded wires to avoid the skin effect. However, if the current becomes larger, the number of stranded wires will be increased accordingly, and thus making the manufacture of the energy storage apparatus difficult.

In addition, the insulating layer covered onto the stranded wires also occupies some space. The more the stranded wires, the larger volume of the coil. The large volume causes inconvenience in the processes of winding wires and connecting printed circuit boards. In addition, the process of winding wires for a plurality of coils is difficult and time-consuming.

In general, the coil of the conventional energy storage apparatus is a flat coil formed by perpendicularly winding a flat conductor, wherein the flat coil has an existing height. Therefore, it is necessary to pass a wire out from an upper edge or a lower edge of the coil when outputting the wire from the inner end of the flat coil. As a result, the total height (which is equal to the thickness of the coil plus the thickness of flat conductor) is increased, and the height of the coil is also increased. Obviously, the increase of total height is not conducive to the reduction of the volume.

In view of the aforementioned problem of the prior art, the discloser of this disclosure based on years of experience in the industry to conduct extensive researches and experiments and finally provided a feasible solution to overcome the problems of the prior art effectively.

### SUMMARY OF THE INVENTION

It is a primary objective of this disclosure to provide an energy storage apparatus capable of reducing the overall volume and inserting components easily and quickly.

To achieve the aforementioned objective, this disclosure provides an energy storage apparatus, comprising: a core having a winding portion, and a first coil including a first coil body and a first pin portion. The first coil body is formed by perpendicularly winding a flat conductor to the winding portion, and the first coil body has a first inner end and a first outer end, and an edge portion of the first coil body has at least one notch to form at least one first wire crossing slot. The first pin portion includes a first inner end pin coupled to the first inner end and a first outer end pin coupled to the first outer end, wherein the first inner end pin passes through the first wire crossing slot and crosses the first coil body.

To achieve the aforementioned objective, this disclosure also provides an energy storage apparatus further comprising a second coil, and the second coil comprises: a second coil body, formed by perpendicularly winding a flat conductor between the first coil body and the winding portion, and having a second inner end and a second outer end, and an edge portion of the second coil body having at least one notch to form a second wire crossing slot; and a second pin portion, including a second inner end pin coupled to the second inner end and a second outer end pin coupled to the second outer end; wherein, the second outer end pin passes through the first wire crossing slot and crosses the first coil body, and the second inner end pin passes through the second wire crossing slot and the first wire crossing slot and crosses the second coil body and the first coil body respectively.

To achieve the aforementioned objective, this disclosure also provides an energy storage apparatus further comprising a third coil, and the third coil comprises: a coil layer module, formed by spirally winding a wire between the first coil body, the second coil body and the winding portion and using the winding portion as an axis; and a third pin portion, coupled to the coil layer module; wherein an edge portion of the first coil body and an edge portion of the second coil body have at least one recess to form a third wire crossing slot, and the third pin portion passes through the third wire crossing slot and crosses the first coil body and the second coil body.

Compared with the prior art, this disclosure has the following advantages and effects: The first coil and/or second coil are formed by perpendicularly winding a flat conductor to replace the coil composed of a plurality of stranded wires, so that the volume can be reduced. Since the coil is coupled to the pin portion, components can be inserted easily and quickly and connected to a printed circuit board by surface mount technology. In addition, the width and depth of each wire crossing slot are determined by the width and thickness of each passing pin, so that when each pin passes through each wire crossing slot and crosses each coil body, the top of each pin is substantially aligned with an edge portion of each coil body, so as to achieve the effect of reducing the height of the coil and reducing the overall volume of the components.

### BRIEF DESCRIPTION OF THE DRAWINGS

FIG. 1 is an exploded view of an energy storage apparatus in accordance with a first embodiment of this disclosure;

FIG. 2 is a blowup view of a first coil in accordance with the first embodiment of this disclosure;

FIG. 3 is a perspective of an energy storage apparatus in accordance with the first embodiment of this disclosure;

FIG. 4 is a bottom view of a first coil in accordance with a second embodiment of this disclosure;

FIG. 5 is a bottom view of a second coil in accordance with the second embodiment of this disclosure;

FIG. 6A is an exploded view of an energy storage apparatus in accordance with the second embodiment of this disclosure, wherein the first and second coils are assembled to each other;

FIG. 6B is a bottom view of an energy storage apparatus in accordance with the second embodiment of this disclosure, wherein the first and second coils are assembled;

FIG. 7 is a perspective view of an energy storage apparatus in accordance with the second embodiment of this disclosure according to FIG. 6A;

FIG. 8 is a cross-sectional view of an energy storage apparatus in accordance with the second embodiment of this disclosure as depicted in FIG. 6B;

FIG. 9 is an exploded view of an energy storage apparatus in accordance with a third embodiment of this disclosure;

FIG. 10 is a top view of an energy storage apparatus in accordance with the third embodiment of this disclosure, wherein, first, second, and third coils are assembled;

FIG. 11 is a perspective view of an energy storage apparatus in accordance with the third embodiment of this disclosure, viewing from a viewing angle;

FIG. 12 is a perspective view of an energy storage apparatus in accordance with the third embodiment of this disclosure, viewing from another viewing angle;

FIG. 13 is a cross-sectional view of an energy storage apparatus in accordance with the third embodiment of this disclosure as depicted in FIG. 10; and

FIG. 14 is a top view of a first coil and a third coil of an energy storage apparatus in accordance with a fourth embodiment of this disclosure.

### DESCRIPTION OF THE PREFERRED EMBODIMENTS

The technical contents of this disclosure will become apparent with the detailed description of preferred embodiments accompanied with the illustration of related drawings as follows. It is intended that the embodiments and figures disclosed herein are to be considered illustrative rather than restrictive.

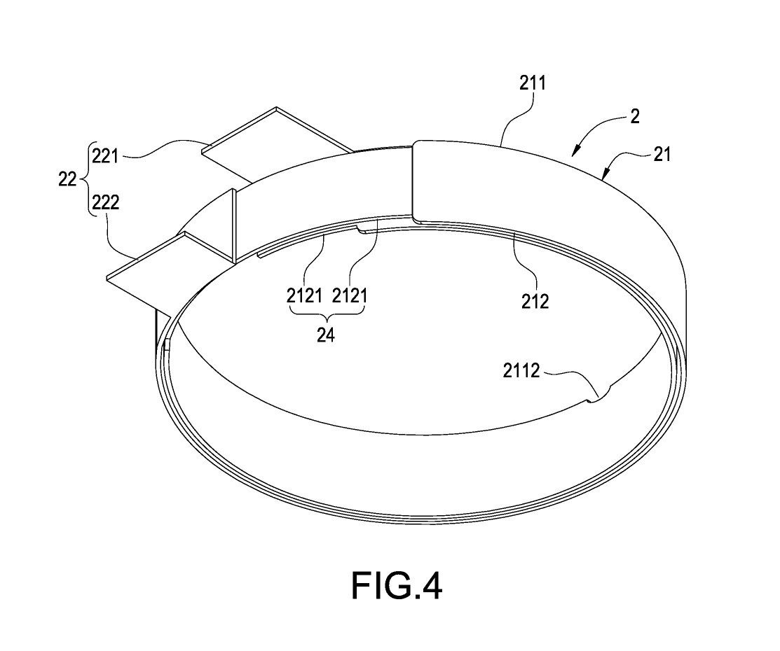

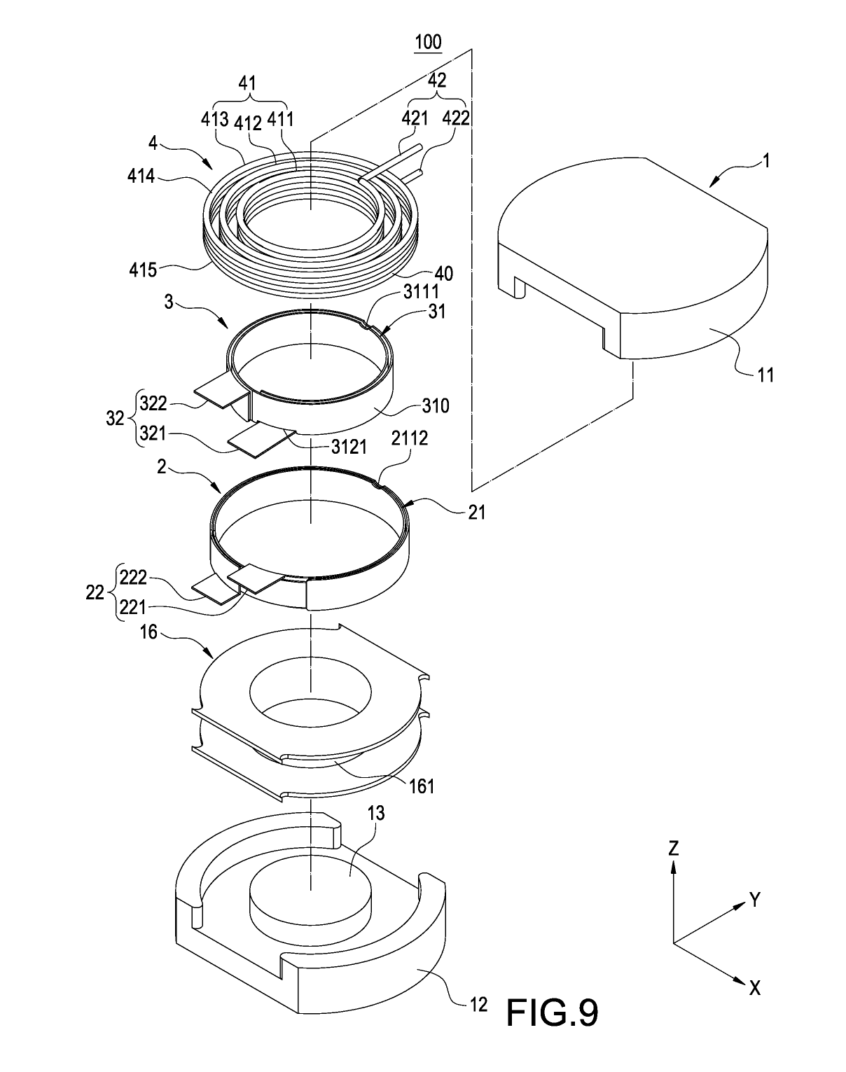

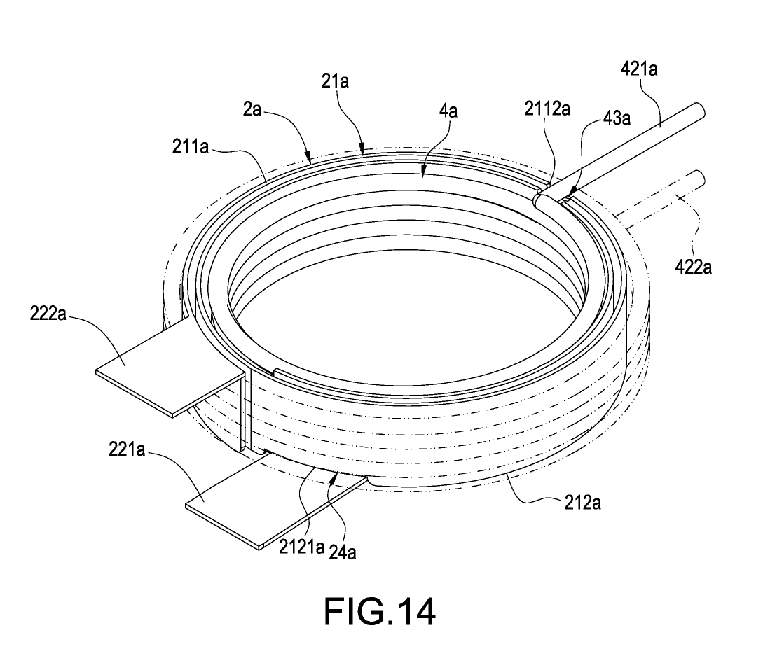

This disclosure discloses an energy storage apparatus which may be an inductor including a single coil (as disclosed in the first embodiment), a transformer including two coils (as disclosed in the second embodiment and shown in FIGS. 4˜8 and as disclosed in the fourth embodiment and shown in FIG. 14), or a transformer including a plurality of coils (as disclosed in the third embodiment and shown in FIGS. 9˜13). However, this disclosure is not limited to the aforementioned embodiments only.

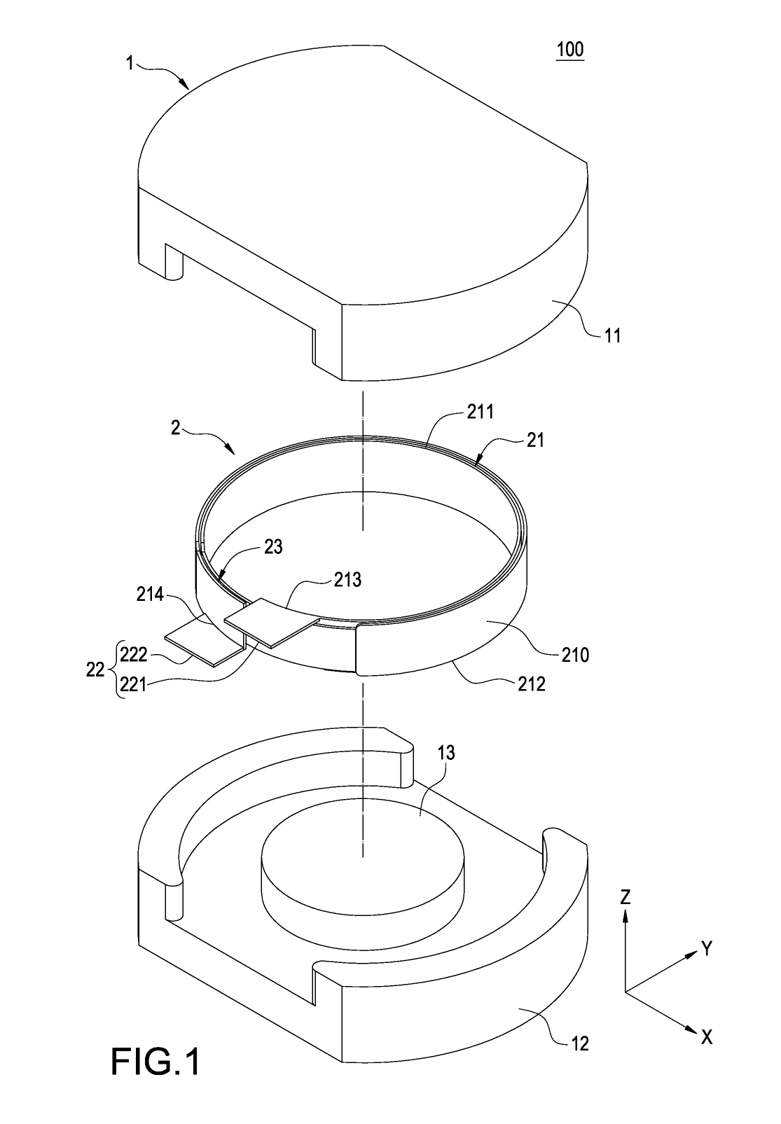

In the first embodiment of this disclosure as shown in FIGS. 1˜3, an energy storage apparatus comprises a core 1 and a first coil 2.

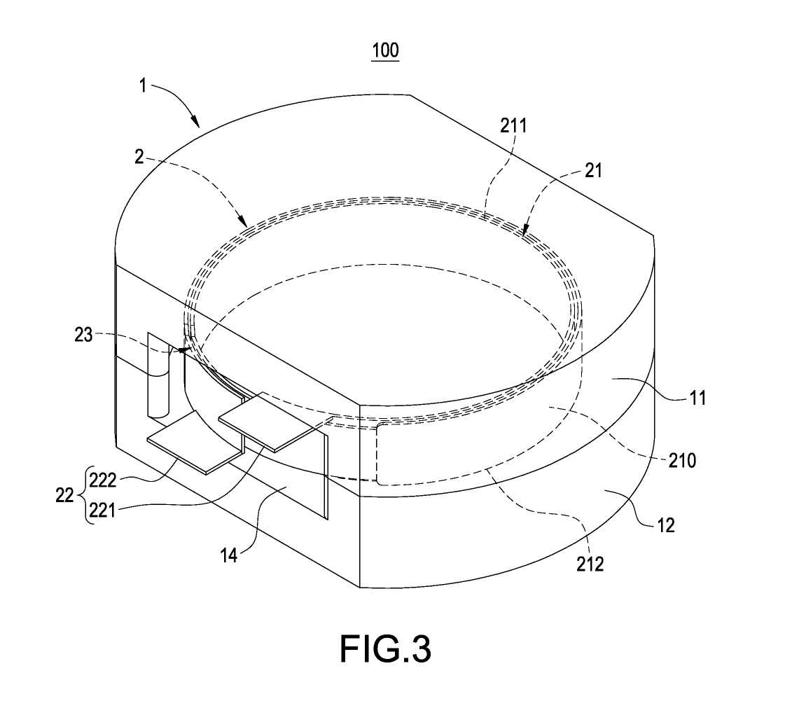

The core 1 may be a single-component I Core (not shown in the figure) having no wire outlet, or a two-component E-E Core or RM Core having at least one wire outlet (as shown in FIGS. 1˜3), but this disclosure is not limited to the aforementioned arrangements only. In the figures, the core (E-E Core) has a first wire outlet 14 as shown in FIG. 3 and includes a first core 11 and a second core 12 engaged with one another.

The core 1 further includes a winding portion provided for winding a coil. In this embodiment, the core 1 has a first winding portion 13.

The first coil 2 includes a first coil body 21 and a first pin portion 22. Wherein, the first coil body 21 has a first inner end 213 and a first outer end 214, and the first pin portion 22 includes a first inner end pin 221 coupled to the first inner end 213 and a first outer end pin 222 coupled to the first outer end 214.

The first coil body 21 is formed by perpendicularly winding a flat conductor 210 to the first winding portion 13. The so-called perpendicular winding refers to the winding conducted by arranging a lateral side of the flat conductor 210 to be substantially perpendicular to a reference plane (not shown in the figure). For example, a lateral side of the flat conductor 210 is arranged substantially parallel to the Z-axis as shown in FIG. 1, so that the flat conductor 210 is substantially perpendicular to the X-Y plane (or reference plane) formed by the X and Y axes as shown in FIG. 1, and then the coil is wound around the first winding portion 13.

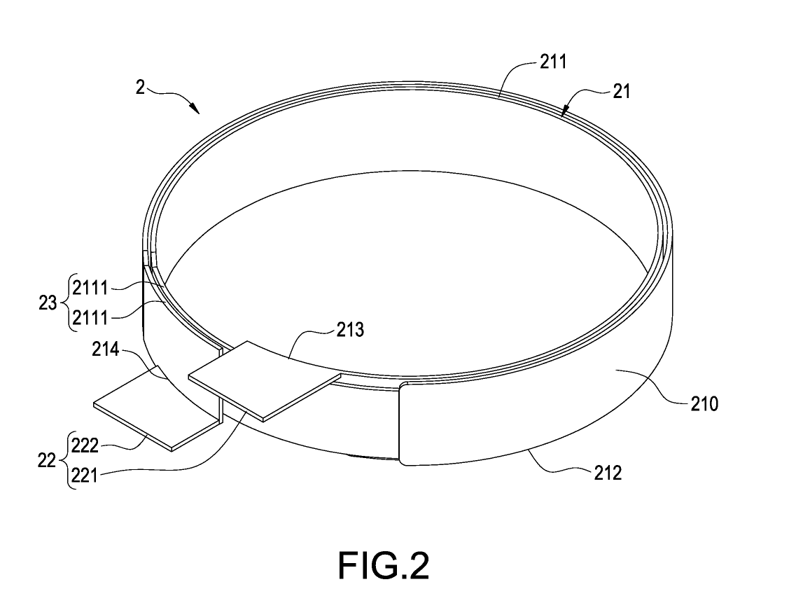

To maintain the first inner end pin 221 (disposed at the inner side of the first coil body 21) and the first outer end pin 222 (disposed at the outer side of the first coil body 21) to be extended out from the core 1 after the first coil 2 is perpendicularly wound, at least one notch is formed at an edge portion of the first coil body 21 for allowing the pin to span over. The aforementioned edge portion may be an upper edge portion 211 and/or a lower edge portion 212. In this embodiment, the upper edge portion 211 has at least one upper notch 2111 (the larger number of coils wound around the first coil body 21, the more the number of upper notches 2111 formed) to form a first wire crossing slot 23 (as shown in FIG. 2).

Therefore, the first inner end pin 221 can pass through the first wire crossing slot 23 and cross the upper edge portion 211 of the first coil body 21, and the first inner end pin 221 and the first outer end pin 222 can be extended out from the core 1 and provided for electrical connection, so as to form the inductive energy storage apparatus 100 in accordance with this disclosure.

Wherein, the first wire crossing slot 23 is formed at a position corresponsive to the first wire outlet 14, so that the first inner end pin 221 can pass through the first wire crossing slot 23 and extend in a direction towards the first wire outlet 14, and the first outer end pin 222 extends directly from the lower edge portion 212 of the first coil body 21 in a direction towards the first wire outlet 14 as shown in FIG. 3, so as to extend both first inner end pin 221 and first outer end pin 222 through the first wire outlet 14 to the outside of the core 1.

In addition, the first inner end pin 221 and the first outer end pin 222 are staggered (as shown in FIGS. 1-3), or arranged opposite to each other (not shown in the figure). This embodiment uses the staggered pins for demonstration, but this disclosure is not limited to the staggered pins only.

Of course, the first inner end pin 221 and the first outer end pin 222 may extend from the upper edge portion 211 or the lower edge portion 212 in a direction towards the first wire outlet 14 at the same time. This disclosure is not limited to this embodiment only.

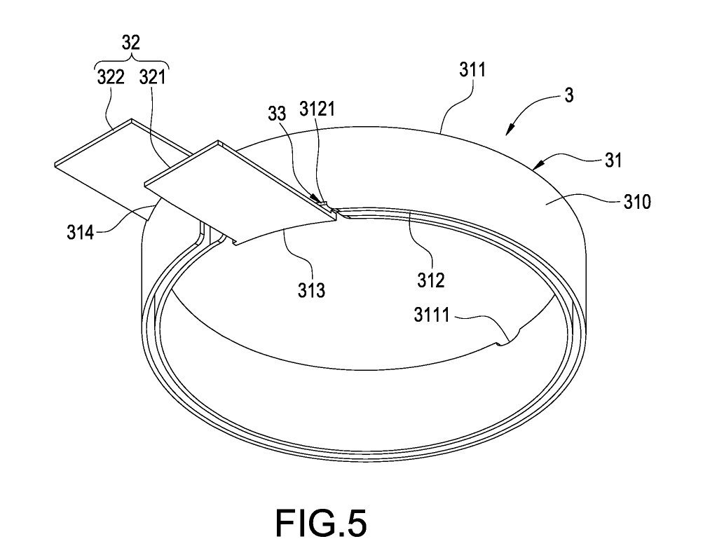

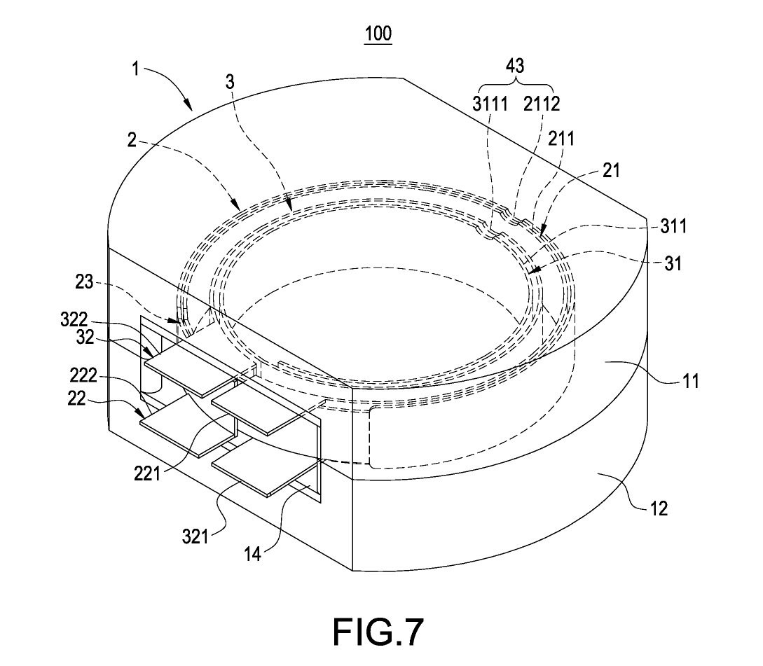

With reference to FIGS. 4-8 for an energy storage apparatus in accordance with the second embodiment of this disclosure, the energy storage apparatus 100 is a transformer type energy storage apparatus 100. The second embodiment is substantially the same as the first embodiment except that the second embodiment further comprises a second coil 3 (as shown in FIG. 5). At least one lower notch 2121 (as shown in FIG. 4) is formed at the lower edge portion 212 of the first coil body 21 to form a first wire crossing slot 24 at the lower edge portion 212, and the first wire crossing slot 24 of the lower edge portion 212 is formed at a position corresponsive to the first wire outlet 14 (as shown in FIG. 7).

The second coil 3 includes a second coil body 31 and a second pin portion 32. In FIG. 5, the second coil body 31 has a second inner end 313 and a second outer end 314, and the second pin portion 32 includes a second inner end pin 321 coupled to the second inner end 313 and a second outer end pin 322 coupled to the second outer end 314.

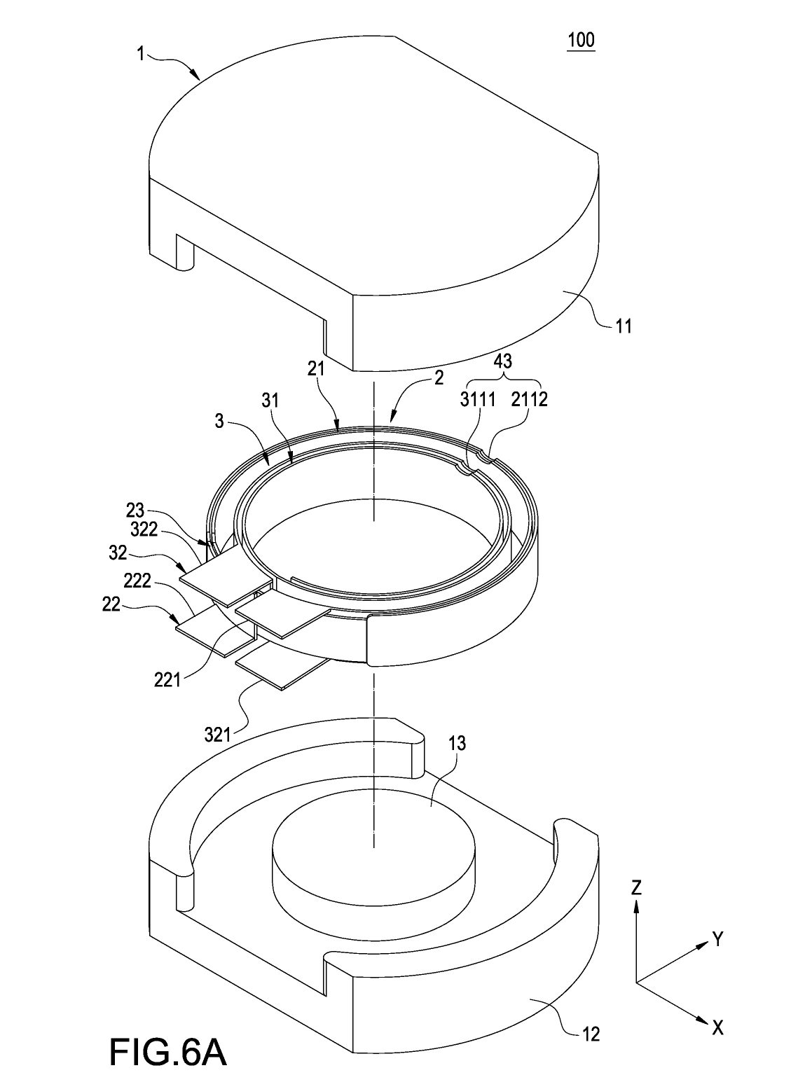

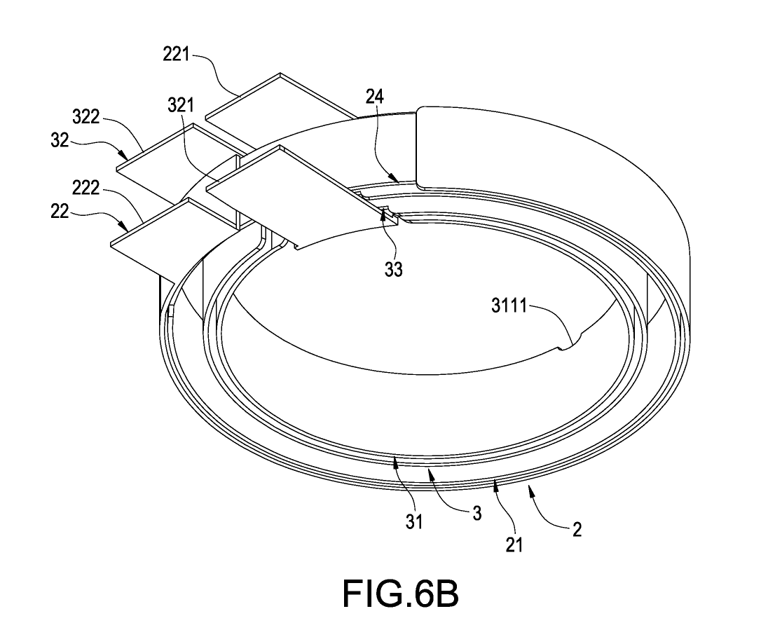

The first coil body 21 and the second coil body 31 are wound around the first winding portion 13 of the core 1 (as shown in FIG. 6A). In this embodiment, the second coil body 3 is disposed between the first coil body 2 and the first winding portion 13.

The second coil body 31 is also formed by perpendicularly winding a flat conductor 310, and the wound second coil body 31 is disposed in the first coil body 21, so that the second pin portion 32 of the second coil 3 must cross its second coil body 31 first before crossing the first coil body 21 and extending towards the first wire outlet 14.

An end of the second coil body 31 has a notch and a recess, wherein the edge portion may be an upper edge portion 311 and/or a lower edge portion 312. In this embodiment, the edge portion is the lower edge portion 312. The lower edge portion 312 has a notch 3121 to form a second wire crossing slot 33, and the second coil body 31 has a second wire crossing slot 33 formed at a position corresponsive to the first wire outlet 14 (as shown in FIG. 7).

Therefore, the second outer end pin 322 of the second coil 3 passes through the first wire crossing slot 23 formed at the upper edge portion 211 and crosses the upper edge portion 211 of first coil body 21 (as shown in FIGS. 6A and 4), and then extends towards the first wire outlet 14 (and the first inner end pin 221 of the first coil 2 also passes through the same first wire crossing slot 23 and crosses the upper edge portion 211 of the first coil body 21), and the second inner end pin 321 passes through the second wire crossing slot 33 and the first wire crossing slot 24 formed at the lower edge portion 212, and crosses the lower edge portion 312 of the second coil body 31 and the lower edge portion 212 of the first coil body 21, and extends towards the first wire outlet 14. Therefore, both second inner end pin 321 and second outer end pin 322 can pass through the first wire outlet 14 and extends out from the core 1 and they are provided for an electrical connection, so as to form the aforementioned transformer type energy storage apparatus 100 of this disclosure.

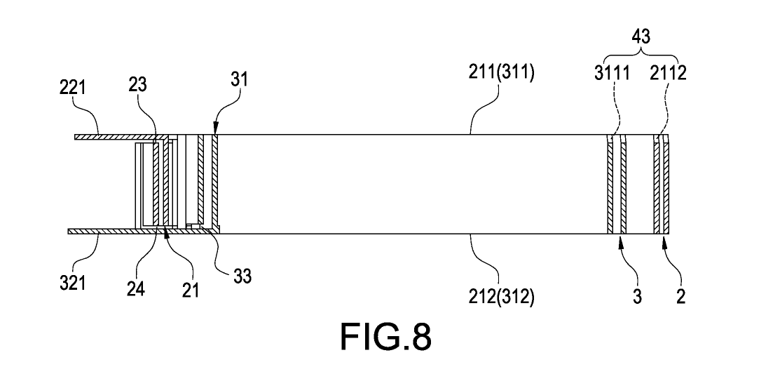

With reference to FIG. 8 together with FIGS. 4˜7, the first wire crossing slots 23, 24 are formed at the upper edge portion 211 and the lower edge portion 212 of the first coil body 21 respectively, and the second wire crossing slot 33 is formed at the lower edge portion 312 of the second coil body 31, and the upper notch 2111, lower notch 2121 and notch 3121 of each wire crossing slot 23, 24, 33 have the width and depth determined by the width and thickness of a pin passing through each wire crossing slot 23, 24, 33.

When the first inner end pin 221 passes through the first wire crossing slot 23 and crosses the first coil body 21, and the second inner end pin 321 passes through the second wire crossing slot 33 and the first wire crossing slot 24 and crosses the second coil body 31 and the first coil body 21, the top of each pin 221, 321 is substantially aligned with the upper edge portion 211, 311 and the lower edge portion 212, 312 of each coil body 21, 31, so as to achieve the effects of reducing the height of the coil and the volume of components. Of course, the first embodiment also has the substantial alignment and achieves the effects of reducing the height of the coil and the volume of components.

With reference to FIGS. 9˜13 for an energy storage apparatus in accordance with the third embodiment of this disclosure, the energy storage apparatus is also a transformer type energy storage apparatus 100. The third embodiment is substantially the same as the second embodiment except that the third embodiment further comprises a third coil 4.

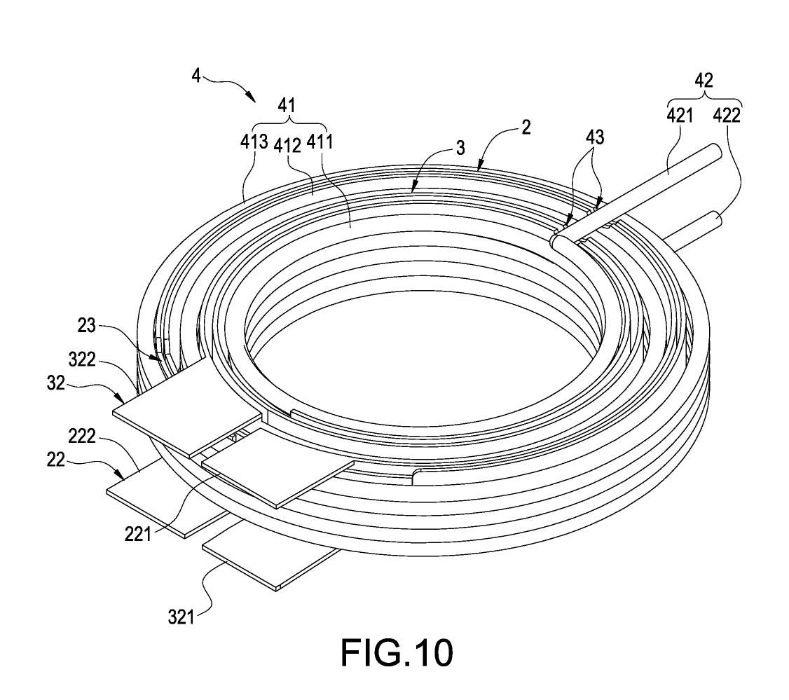

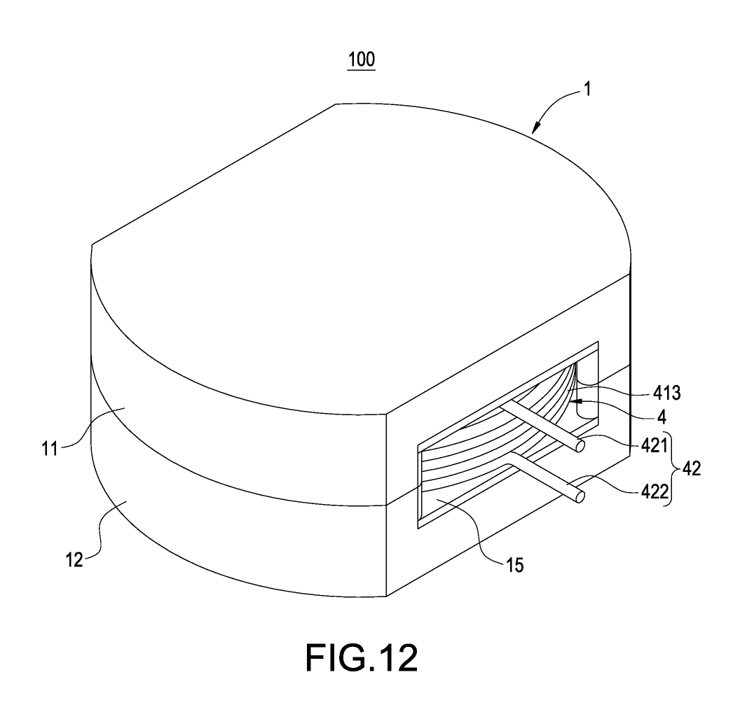

In addition, the core 1 further includes a second wire outlet 15 (as shown in FIG. 12), and the upper edge portion 211 of the first coil body 21 has at least one recess 2112 formed at a position corresponsive to the second wire outlet 15 (as shown in FIG. 9). The upper edge portion 311 of the second coil body 31 has at least one recess 3111 formed at a position corresponsive to the second wire outlet 15, and the recesses 2112, 2111 jointly form a third wire crossing slot 43 (as shown in FIG. 10).

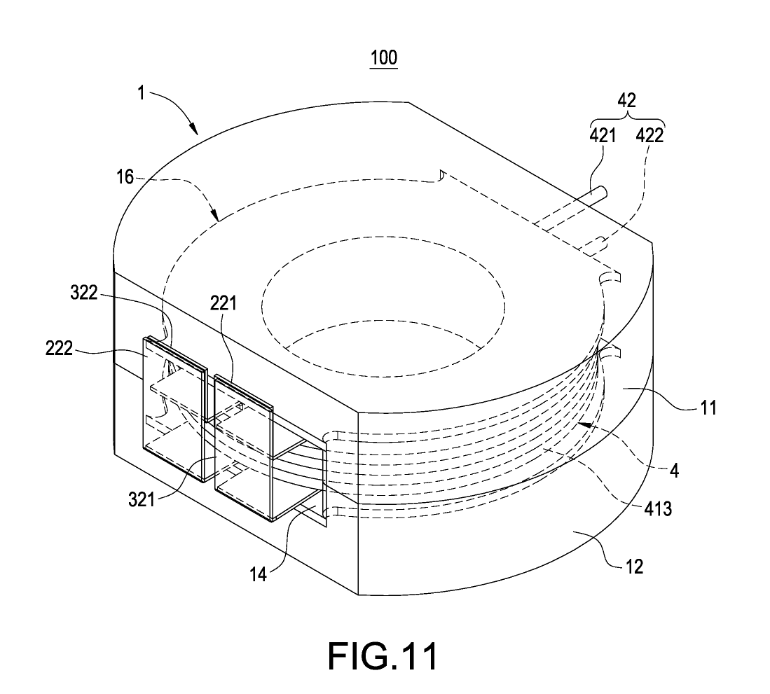

The core 1 further includes a bobbin 16 (as shown in FIGS. 9 and 11) sheathed on the first winding portion 13, and the bobbin 16 has a second winding portion 161, and the second coil body 31 is disposed between the first coil body 21 and the second winding portion 161.

The third coil 4 includes a coil layer module 41 and a third pin portion 42 coupled to the coil layer module 41. In FIG. 9, the coil layer module 41 is formed by winding a wire 40 spirally and perpendicularly thereon and using the second winding portion 161 as an axis, and one or more coil layers such as 1, 3, 5 or more layers arranged with an internal apart and adjacent to one another are wound. In this embodiment, three coil layers 411, 412, 413 are used for demonstration. The third pin portion 42 includes a third inner end pin 421 and a third outer end pin 422.

The so-called perpendicular winding refers to the winding of a wire 40 spirally round by round in a direction parallel to the Z-axis as shown in FIG. 4 until the wire is stacked to a specific height to form at least one coil layer (411, or 412, or 413). Of course, three coil layers (such as 411, 412, and 413) are wound continuously. The third inner end pin 421 is coupled to the innermost coil layer 411, and the third outer end pin 422 is coupled to the outermost coil layer 413.

The first coil body 21 and the second coil body 31 are disposed between two adjacent coil layers (to form a five-layer sandwiched winding structure). In this embodiment as shown in FIG. 10, the first coil body 21 is disposed between the coil layers 411, 412, and the second coil body 31 is disposed between the coil layers 412, 413.

The third inner end pin 421 passes through the third wire crossing slot 43 and crosses the upper edge portion 211 of the first coil body 21 and the upper edge portion 311 of the second coil body 31, so that the third inner end pin 421 as well as the third outer end pin 422 can extend towards the second wire outlet 15, and both pins 421, 422 pass through the second wire outlet 15 and extend out from the core 1 (as shown in FIG. 12).

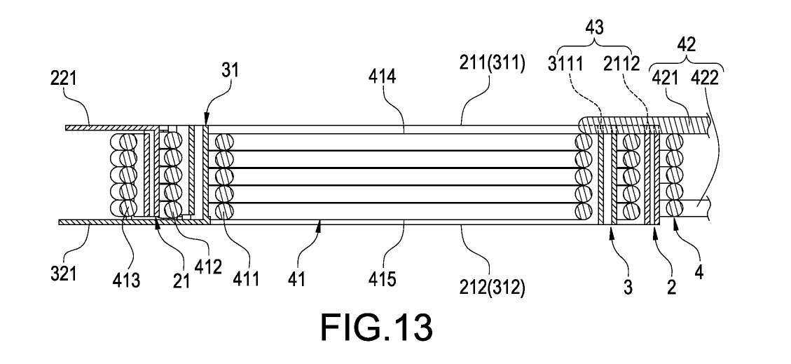

In FIG. 13, recesses 2112, 3111 are formed at the upper edge portion 211 (or lower edge portion 212) of the first coil body 21 and the upper edge portion 311 (or lower edge portion 312) of the second coil body 31 respectively to jointly form a third wire crossing slot 43, and the width and depth of the recesses 2112, 3111 of the third wire crossing slot 43 are determined by the width and thickness of the third inner end pin 421 passing through the third wire crossing slot 43.

When the third inner end pin 421 passes through the third wire crossing slot 43 and crosses the first coil body 21 and the second coil body 31, the upper edge portion of the third inner end pin 421 descends in a direction towards the lower edge portion 415 and to a position closer to the upper edge portion 414, so as to achieve the effects of reducing the height of the coil and the volume of components.

In the second or third embodiment, the second inner end pin 321 and the second outer end pin 322 of the first wire outlet 14 are staggered (as shown in FIG. 5 or 9), or arranged opposite to each other (not shown in the figure). In the second or third embodiment, the staggered pins are used for demonstration. Therefore, the first inner end pin 221 and the first outer end pin 222 of the first coil 2 are staggered with the second inner end pin 321 and the second outer end pin 322 of the second coil 3 (which are staggered in an X-shape with respect to each other as shown in FIG. 6A), so as to facilitate the pins disposed between the first coil 2 and the second coil 3 and having the same polarity to connect with each other. For example, the first inner end pin 221 of the first coil 2 is coupled to the second inner end pin 321 (or second outer end pin 322) having the same polarity of the second coil 3 (as shown in FIG. 11), and the first outer end pin 222 of the first coil 2 is coupled to the second outer end pin 322 (or second inner end pin 321) having the same polarity of the second coil 3 (as shown in FIG. 11).

The connection of pins is not limited to the aforementioned method only, and the pins of the same polarity may be soldered or screwed with each other (not shown in the figure), or the pins of the same polarity may be bent to contact with each other (as shown in FIG. 11). If the pins of the same polarity are connected to form two electrodes (not labeled), the two electrodes may be plugged into two jacks (not shown in the figure) of a printed circuit board respectively to provide a simple, easy, and quick effect of inserting components. If the pins of the same polarity are not connected first, then four pins (221, 222, 321, and 322) may be plugged into four jacks (not shown in the figure) of the printed circuit board respectively.

With reference to FIG. 14 for an energy storage apparatus in accordance with the fourth embodiment of this disclosure, the energy storage apparatus is also a transformer type energy storage apparatus 100. The fourth embodiment is substantially the same as the third embodiment, except that the plurality of coils refers to the first coil 2a and the third coil 4a, and the fourth embodiment does not include the second coil 3.

Further, the structure of the third coil 4a is substantially the same as that of the third coil 3 of the third embodiment, except that the coil layer module just includes two coil layer arranged with an interval apart and adjacent to each other. The third pin portion 422a includes a third inner end pin 421a and a third outer end pin 422a coupled to the coil layer module.

An edge portion (such as an upper edge portion 211a or a lower edge portion 212a, and this embodiment uses the upper edge portion 211a for demonstration) of the first coil body 21a has at least one recess 2112a to form a third wire crossing slot 43a, and the first coil body 21a is disposed between two adjacent coil layers. Now, the third inner end pin 421a passes through the third wire crossing slot 43a and crosses the upper edge portion 211a of the first coil body 21a.

An edge portion of the first coil body 21a (such as the upper edge portion 211a or the lower edge portion 212a, and this embodiment uses the lower edge portion 212a for demonstration) has at least one lower notch 2112a to form a first wire crossing slot 24a. Now, the first inner end pin 221a passes through the first wire crossing slot 24a and crosses the lower edge portion 212a of the first coil body 21a.

In summation of the description above, this disclosure has the following improvement over the prior art: The first coil 2 and/or the second coil 3 formed by perpendicularly winding the flat conductor 210(310) replaces the conventional coil composed of a plurality of stranded wires, so that the volume can be reduced (since there will be no stranded wires, or the number of stranded wires occupied in the insulating layer is reduced). In addition, the coil is coupled to the pin portion 22(32), so that components can be inserted easily and quickly and connected to a printed circuit board by surface mount technology.

In addition, this disclosure also has the following effect: The wire crossing slot (such as the first wire crossing slot 23, 24, 24a, the second wire crossing slot 33 and/or the third wire crossing slot 43, 43a) is formed at an edge portion of the coil (such as the first coil 2, 2a and/or the second coil 3), so that the pin of each coil can pass through the corresponsive wire crossing slot and cross the edge portion of each coil, and the width and depth of each wire crossing slot are determined by the width and thickness of each pin passing through the wire crossing slot. When each pin passes through each wire crossing slot and crosses each coil body, the top of each pin is substantially aligned with the edge portion of each coil body, or the top of the third inner end pin 421 descends in a direction towards the lower edge portion 415 of the coil layer module 41 to a position closer to the upper edge portion 414, so as to achieve the effects of reducing the height of the coil and the volume of components.

The first inner end pin 221 and the first outer end pin 222 of the first coil 2 are staggered with the second inner end pin 321 and the second outer end pin 322 of the second coil 3, and the staggered pins can save winding space and facilitate the connection of the pins of the same polarity.

The first and second coil bodies 21, 31 are disposed between any two adjacent coil layers (411, 412 and 412, 413) of the third coil 4 to form a five-layer sandwiched winding structure to improve the coupling effect of the high-voltage and low-voltage side coils 9 (wherein the third coil 4 is the high-voltage side coil, and the first coil 2 and the second coil 3 are low-voltage side coils). The better the coupling effect of the transformer, the less the leakage inductance. The less leakage inductance, the lower the switch surge. Therefore, the loss can be minimized to improve efficiency effectively.

While this disclosure has been described by means of specific embodiments, numerous modifications and variations could be made thereto by those skilled in the art without departing from the scope and spirit of this disclosure set forth in the claims.

What is claimed is:

1. An energy storage apparatus, comprising:
a core, having a winding portion; and
a first coil, including:
a first coil body, formed by perpendicularly winding a flat conductor to the winding portion, and having a first inner end and a first outer end, and an edge portion of the first coil body having at least one notch to form at least one first wire crossing slot; and
a first pin portion, including a first inner end pin coupled to the first inner end and a first outer end pin coupled to the first outer end;
wherein, the first inner end pin passes through the first wire crossing slot and crosses the first coil body.

2. The energy storage apparatus according to claim 1, wherein the core further includes a first wire outlet, and the first coil body has the first wire crossing slot formed at a position corresponsive to the first wire outlet, and the first inner end pin passes through the first wire crossing slot and extends in a direction towards the first wire outlet.

3. The energy storage apparatus according to claim 2, wherein the edge portion of the first coil body including an upper edge and a lower edge, and the first inner end pin crosses the upper edge of the first coil body, and the first outer end pin extends from the lower edge of the first coil body in a direction towards the first wire outlet.

4. The energy storage apparatus according to claim 1, further comprising a second coil, and the second coil including:
a second coil body, formed by perpendicularly winding a flat conductor between the first coil body and the winding portion, and having a second inner end and a second outer end, and an edge portion of the second coil body having at least one notch to form a second wire crossing slot; and
a second pin portion, including a second inner end pin coupled to the second inner end and a second outer end pin coupled to the second outer end;
wherein, the second outer end pin passes through the first wire crossing slot and crosses the first coil body, and the second inner end pin passes through the second wire crossing slot and the first wire crossing slot and crosses the second coil body and the first coil body respectively.

5. The energy storage apparatus according to claim 4, wherein the first inner end pin of the first coil is coupled to the second inner end pin or the second outer end pin having the same polarity of the second coil, and the first outer end pin of the first coil is coupled to the second inner end pin or the second outer end pin having the same polarity of the second coil.

6. The energy storage apparatus according to claim 4, wherein the core further includes a first wire outlet, and the first coil body has the first wire crossing slot formed at a position corresponsive to the first wire outlet, and the first inner end pin passes through the first wire crossing slot and extends in a direction towards the first wire outlet, and the second coil body has the second wire crossing slot formed at a position corresponsive to the first wire outlet, and the second outer end pin passes through the first wire crossing slot and extends in a direction towards the first wire outlet, and the second inner end pin passes through the second wire crossing slot and the first wire crossing slot and extends in a direction towards the first wire outlet.

7. The energy storage apparatus according to claim 6, wherein the first inner end pin of the first coil is coupled to the second inner end pin or the second outer end pin having the same polarity of the second coil, and the first outer end pin of the first coil is coupled to the second inner end pin or the second outer end pin having the same polarity of the second coil.

8. The energy storage apparatus according to claim 6, wherein the edge portion of the first coil body including an upper edge and a lower edge, and the first inner end pin crosses the upper edge of the first coil body, and the first outer end pin extends from the lower edge of the first coil body in a direction towards the first wire outlet, and the edge portion of the second coil body including an upper edge and a lower edge, and the second inner end pin crosses the lower edge of the second coil body and the lower edge of the first coil body, and the second outer end pin crosses the upper edge of the first coil body.

9. The energy storage apparatus according to claim 8, wherein the first inner end pin of the first coil is coupled to the second inner end pin or the second outer end pin having the same polarity of the second coil, and the first outer end pin of the first coil is coupled to the second inner end pin or the second outer end pin having the same polarity of the second coil.

10. The energy storage apparatus according to claim 4, further comprising a third coil, and the third coil including:
a coil layer module, formed by spirally winding a wire between the first coil body, the second coil body and the winding portion and using the winding portion as an axis; and
a third pin portion, coupled to the coil layer module;
wherein the edge portion of the first coil body and the edge portion of the second coil body have at least one recess to form a third wire crossing slot, and the third pin portion passes through the third wire crossing slot and crosses the first coil body and the second coil body.

11. The energy storage apparatus according to claim 10, wherein the first inner end pin of the first coil is coupled to the second inner end pin or the second outer end pin having the same polarity of the second coil, and the first outer end pin of the first coil is coupled to the second inner end pin or the second outer end pin having the same polarity of the second coil.

12. The energy storage apparatus according to claim 10, wherein the core further includes a first wire outlet and a second wire outlet, and the first coil body has the first wire crossing slot formed at a position corresponsive to the first wire outlet, and the first inner end pin passes through the first wire crossing slot and extends in a direction towards the first wire outlet, and the second coil body has the second wire crossing slot formed at a position corresponsive to the first wire outlet, and the second outer end pin passes through the first wire crossing slot and extends in a direction towards the first wire outlet, and the second inner end pin passes through the second wire crossing slot and the first wire crossing slot and extends in a direction towards the first wire outlet, and the first coil body and the second coil body have the third wire crossing slot formed at a position corresponsive to the second wire outlet, and the third pin portion passes through the third wire crossing slot and extends in a direction towards the second wire outlet.

13. The energy storage apparatus according to claim 12, wherein the first inner end pin of the first coil is coupled to the second inner end pin or the second outer end pin having the same polarity of the second coil, and the first outer end pin of the first coil is coupled to the second inner end pin or the second outer end pin having the same polarity of the second coil.

14. The energy storage apparatus according to claim 1, further comprising a third coil, and the third coil including:
a coil layer module, formed by spirally winding a wire between the first coil body and the winding portion and using the winding portion as axis; and
a third pin portion, coupled to the coil layer module;
wherein, the edge portion of the first coil body has at least one recess to form a third wire crossing slot, and the third pin portion passes through the third wire crossing slot and crosses the first coil body.

15. The energy storage apparatus according to claim 14, wherein the core further includes a first wire outlet and a second wire outlet, and the first coil body has the first wire crossing slot formed at a position corresponsive to the first wire outlet, and the first inner end pin passes through the first wire crossing slot and extends in a direction towards the first wire outlet, and the first coil body has the third wire crossing slot formed at a position corresponsive to the second wire outlet, and the third pin portion passes through the third wire crossing slot and extends in a direction towards the second wire outlet.
